(19) United States
(12) Patent Application Publication
(10) Pub. No.: US 2026/0062313 A1
(43) Pub. Date: Mar. 5, 2026

(54) NICKEL-CONTAINING HYDROXIDE, CATHODE ACTIVE MATERIAL WITH NICKEL-CONTAINING HYDROXIDE AS PRECURSOR, AND METHOD FOR PRODUCING NICKEL-CONTAINING HYDROXIDE

(71) Applicant: TANAKA CHEMICAL CORPORATION, Fukui (JP)

(72) Inventor: Yudai YASUNO, Fukui (JP)

(73) Assignee: TANAKA CHEMICAL CORPORATION, Fukui (JP)

(21) Appl. No.: 19/311,803

(22) Filed: Aug. 27, 2025

(30) Foreign Application Priority Data
Aug. 28, 2024 (JP) 2024-146277

(51) Int. Cl. C01G 53/05; H01M 10/0525

(52) U.S. Cl. CPC C01G 53/05; H01M 10/0525; C01P 2006/12; C01P 2006/40

(57) ABSTRACT

Provided is a nickel-containing hydroxide as a precursor of a cathode active material for a non-aqueous electrolyte secondary battery, wherein the nickel-containing hydroxide is secondary particles formed by agglomeration of a plurality of primary particles, and the primary particles have an average area of 0.035 μm² or more.

### CROSS REFERENCE TO RELATED APPLICATIONS

The present application claims the benefit of foreign priority to Japanese Patent Application No. 2024-146277, filed on Aug. 28, 2024, which is incorporated herein by reference in its entirety.

### BACKGROUND

### Technical Field

The present disclosure relates to a nickel-containing hydroxide, a cathode active material with the nickel-containing hydroxide as a precursor, and a method for producing the nickel-containing hydroxide, and in particular, a nickel-containing hydroxide with which a cathode active material having excellent initial charge-discharge efficiency can be obtained, and a method for producing the nickel-containing hydroxide.

### Description of the Related Art

In recent years, secondary batteries have been used in a wide range of fields, such as portable devices including mobile phones and portable personal computers, and vehicles that use or combine electricity as a power source, in order to reduce the environmental burden. Secondary batteries include, for example, lithium-ion secondary batteries using non-aqueous electrolytes. Secondary batteries using non-aqueous electrolytes, such as lithium-ion secondary batteries, are suitable for miniaturization and weight reduction, and have characteristics such as high utilization and high cycle characteristics.

To improve battery characteristics of lithium-ion secondary batteries, high battery capacity and high output characteristics are required. As a precursor of a cathode active material for a non-aqueous electrolyte secondary battery achieving high battery capacity and high output characteristics, a nickel-manganese composite hydroxide has been proposed, which is represented by the formula (1): NiₓMn_{y}M_{z}(OH)_{2+α} (wherein M is at least one additive element selected from Co, Ti, V, Cr, Zr, Nb, Mo, Hf, Ta, Fe and W, x is 0.1≤x≤0.8, y is 0.1≤y≤0.6, z is 0≤z≤0.8, and x+y+z=1.0 is satisfied, and a is 0≤α≤0.4), wherein the nickel-manganese composite hydroxide contains a secondary particle formed of a plurality of flocculated primary particles, the primary particles have an aspect ratio of 3 or more, and at least some of the primary particles are disposed radially from a central part of the secondary particle toward an outer circumference, and the secondary particle has a ratio I(101)/I(001) of a diffraction peak intensity I(101) of a 101 plane to a peak intensity I(001) of a 001 plane, measured by an X-ray diffraction measurement, of 0.15 or less (International Publication No. WO 2018-020845).

International Publication No. WO 2018-020845 discloses that the particle structure of the positive electrode active material is significantly influenced by the particle structure and crystallinity of a composite hydroxide which is a precursor of the positive electrode active material, and thus, by controlling the particle structure and crystallinity of the composite hydroxide, characteristics of the positive electrode active material can be improved and high battery capacity and high output characteristics can be achieved. International Publication No. WO 2018-020845 also discloses that the particle structure and crystallinity of the composite hydroxide are controlled by using a certain crystallization condition.

On the other hand, in portable devices such as mobile phones and portable personal computers, electric vehicles using electricity as a power source, or hybrid vehicles combining electricity as a power source, in particular, high initial charge-discharge efficiency is required for the non-aqueous electrolyte secondary battery serving as the power source. However, with respect to a precursor of the cathode active material disclosed in International Publication No. WO 2018-020845, the initial charge-discharge efficiency of non-aqueous electrolyte secondary batteries has room for further improvement.

The present disclosure relates to provide a nickel-containing hydroxide that can yield a cathode active material having excellent initial charge-discharge efficiency, and a method for producing the nickel-containing hydroxide.

### SUMMARY

A nickel-containing hydroxide is secondary particles formed by agglomeration of a plurality of primary particles, and the average area of the primary particles forming the secondary particles is adjusted to a predetermined range.

The summary of the configuration of the present disclosure is as follows.

[1] A nickel-containing hydroxide as a precursor of a cathode active material for a non-aqueous electrolyte secondary battery, wherein the nickel-containing hydroxide is secondary particles formed by agglomeration of a plurality of primary particles, and the primary particles have an average area of 0.035 μm² or more.

[2] The nickel-containing hydroxide according to [1], wherein the primary particles have an average area of 0.100 μm² or less.

[3] The nickel-containing hydroxide according to [1] or [2], wherein the primary particles have an average area of 0.039 μm² or more and 0.080 μm² or less.

[4] The nickel-containing hydroxide according to any one of [1] to [3], wherein the nickel-containing hydroxide comprises 80 mol % or more of nickel (Ni) relative to the total amount of metals in the nickel-containing hydroxide.

[5] The nickel-containing hydroxide according to [4], wherein the nickel-containing hydroxide is a composite hydroxide comprising nickel (Ni) and at least one metal selected from the group consisting of cobalt (Co) and manganese (Mn).

[6] The nickel-containing hydroxide according to [4], wherein the nickel-containing hydroxide is a composite hydroxide in which a molar ratio among nickel (Ni): cobalt (Co): manganese (Mn): an additive element M is represented by (1-x-y-z):x:y:z (0≤x≤0.15, 0≤y≤0.15, 0≤z≤0.05, and M is one or more additive elements selected from the group consisting of Al, Fe, Ti, Mg, Ca, Sr, Ba, V, Nb, Cr, Mo, W, Ru, Cu, Zn, B, Ga, Si, Sn, P, Bi, and Zr).

[7] A cathode active material for a non-aqueous electrolyte secondary battery, wherein the cathode active material is formed by calcining the nickel-containing hydroxide according to any one of [1] to [6] with a lithium compound.

[8] A method for producing a nickel-containing hydroxide as a precursor of a cathode active material for a non-aqueous electrolyte secondary battery, wherein the nickel-containing hydroxide is secondary particles formed by agglomeration of a plurality of primary particles, the method comprising:
a reaction step of obtaining the nickel-containing hydroxide by a crystallization reaction by continuously supplying a metal-containing aqueous solution containing nickel, a complexing agent, and an alkaline aqueous solution to a reaction tank, and
a slurry extraction step of continuously extracting a slurry containing the nickel-containing hydroxide from the reaction tank,
wherein a flow rate of the metal-containing aqueous solution containing nickel supplied to the reaction tank in the reaction step is 0.25 m/s or less.

[9] The method for producing a nickel-containing hydroxide according to [8], wherein the flow rate of the metal-containing aqueous solution containing nickel supplied to the reaction tank in the reaction step is 0.01 m/s or more.

[10] The method for producing a nickel-containing hydroxide according to [8] or [9], further comprising a solid-liquid separation step in which the nickel-containing hydroxide obtained in the slurry extraction step is washed with an alkaline aqueous solution and then subjected to solid-liquid separation.

In the present description, the term “average area of primary particles” refers to the average area of primary particles calculated by obtaining an image of secondary particles of the nickel-containing hydroxide by scanning electron microscope (SEM) observation at a magnification of 5,000 times, selecting, from the obtained image, secondary particles having a particle size at a cumulative volume percentage of 50% (D50) (+10%) as measured by a particle size distribution measurement device using the laser diffraction-scattering method, randomly selecting, from a scanning electron microscope (SEM) image of the selected secondary particles at a magnification of 20,000 times, 40 primary particles on the surface, measuring the area of the selected primary particles using an image processing software “ImageJ,” and calculating the average area of the primary particles from the areas of the 40 measured primary particles.

According to an embodiment of the nickel-containing hydroxide of the present disclosure, which is a precursor of a cathode active material for a non-aqueous electrolyte secondary battery, when the primary particles have an average area of 0.035 μm² or more, a non-aqueous electrolyte secondary battery having excellent initial charge-discharge efficiency can be obtained.

According to an embodiment of the nickel-containing hydroxide of the present disclosure, when the primary particles have an average area of 0.035 μm² or more and 0.100 μm² or less, a non-aqueous electrolyte secondary battery having excellent initial charge-discharge efficiency can be obtained.

According to an embodiment of the cathode active material of the present disclosure, when the nickel-containing hydroxide of the present disclosure is calcined with a lithium compound, a non-aqueous electrolyte secondary battery having excellent initial charge-discharge efficiency can be obtained.

According to an embodiment of the method for producing a nickel-containing hydroxide of the present disclosure, when the flow rate of the metal-containing aqueous solution containing nickel supplied to the reaction tank in the reaction step is 0.25 m/s or less, the average area of the primary particles of the nickel-containing hydroxide can be adjusted to 0.035 μm² or more, and as a result, a non-aqueous electrolyte secondary battery having excellent initial charge-discharge efficiency can be obtained.

According to an embodiment of the method for producing a nickel-containing hydroxide of the present disclosure, when the flow rate of the metal-containing aqueous solution containing nickel supplied to the reaction tank in the reaction step is 0.01 m/s or more and 0.25 m/s or less, the average area of the primary particles of the nickel-containing hydroxide can be more effectively adjusted to 0.035 μm² or more, and as a result, a non-aqueous electrolyte secondary battery having higher initial charge-discharge efficiency can be obtained.

### DETAILED DESCRIPTION

Hereinafter, the nickel-containing hydroxide of the present disclosure, which is a precursor of a cathode active material for a non-aqueous electrolyte secondary battery, will be described in detail. The nickel-containing hydroxide of the present disclosure is secondary particles formed by agglomeration of a plurality of primary particles. The shape of the particles of the nickel-containing hydroxide of the present disclosure is not particularly limited, and may include various shapes, such as a substantially spherical or substantially ellipsoidal shape.

The primary particles of nickel-containing hydroxide of the present disclosure have an average area of 0.035 μm² or more. For the above reason, the average area of the primary particles forming the nickel-containing hydroxide which is secondary particles is adjusted to 0.035 μm² or more. In other words, the nickel-containing hydroxide of the present disclosure comprises secondary particles formed by agglomeration of a plurality of primary particles, and the primary particles on the surface of the nickel-containing hydroxide have an average area of 0.035 μm² or more.

The primary particles of nickel-containing hydroxide of the present disclosure have an average area of 0.035 μm² or more. Therefore, by using a cathode active material prepared from the nickel-containing hydroxide of the present disclosure for a non-aqueous electrolyte secondary battery, a non-aqueous electrolyte secondary battery having excellent initial charge-discharge efficiency can be obtained.

The average area of the primary particles is not particularly limited as long as it is 0.035 μm² or more, and from the viewpoint of obtaining a non-aqueous electrolyte secondary battery having excellent initial charge-discharge efficiency, the lower limit value of the average area of the primary particles is preferably 0.037 μm² or more, and particularly preferably 0.039 μm² or more. On the other hand, the upper limit value of the average area of the primary particles is preferably 0.100 μm² or less, more preferably 0.090 μm² or less, and particularly preferably 0.080 μm² or less from the viewpoint of obtaining a non-aqueous electrolyte secondary battery having excellent initial charge-discharge efficiency. The lower limit value and the upper limit value described above may be optionally combined. The average area of the primary particles of the nickel-containing hydroxide of the present disclosure is, for example, preferably 0.035 μm² or more and 0.100 μm² or less, more preferably 0.037 μm² or more and 0.090 μm² or less, and particularly preferably 0.039 μm² or more and 0.080 μm² or less.

The particle size at a cumulative volume percentage of 50% (D50) (hereinafter sometimes simply referred to as “D50”) of the nickel-containing hydroxide of the present disclosure is not particularly limited, and the lower limit value is preferably 5.0 μm or more, more preferably 7.0 μm or more, and particularly preferably 10.0 μm or more from the viewpoint of improved packing density of the cathode active material in the cathode. On the other hand, the upper limit value of D50 of the nickel-containing hydroxide of the present disclosure is preferably 15.0 μm or less, more preferably 14.0 μm or less, and particularly preferably 13.0 μm or less from the viewpoint of the improvement in the contact with the electrolyte. D50 described above refers to a particle size measured by a particle size distribution measurement device using a laser diffraction scattering method. The lower limit value and the upper limit value described above may be optionally combined. For example, D50 of the nickel-containing hydroxide of the present disclosure is preferably 5.0 μm or more and 15.0 μm or less, more preferably 7.0 μm or more and 14.0 μm or less, and particularly preferably 10.0 μm or more and 13.0 μm or less.

The shape of the primary particles of the nickel-containing hydroxide of the present disclosure is not particularly limited, and examples include spherical, ellipsoidal, plate-like, and columnar shapes.

The composition of the nickel-containing hydroxide of the present disclosure is not particularly limited as long as the hydroxide includes nickel (Ni). The nickel content in the nickel-containing hydroxide of the present disclosure is not particularly limited, and the lower limit value is preferably 80 mol % or more, and particularly preferably 82 mol % or more relative to the total amount of the metal elements in the nickel-containing hydroxide from the viewpoint of reducing raw material cost while obtaining a cathode active material having improved physical properties such as initial charge-discharge efficiency, high utilization rates, and high cycle characteristics. On the other hand, the upper limit value of the nickel content in the nickel-containing hydroxide of the present disclosure is 100 mol % or less, preferably 95 mol % or less and particularly preferably 90 mol % or less relative to the total amount of the metal elements from the viewpoint of obtaining a cathode active material having improved physical properties such as initial charge-discharge efficiency, high utilization rates, and high cycle characteristics. The upper limit value and the lower limit value described above may be optionally combined.

For the composition of the nickel-containing hydroxide of the present disclosure, for example, a composite hydroxide including nickel (Ni), and at least one metal selected from the group consisting of cobalt (Co) and manganese (Mn) may be available. Specific examples of the composition of the nickel-containing hydroxide of the present disclosure include a composite hydroxide in which the molar ratio among nickel (Ni): cobalt (Co): manganese (Mn): an additive element M is represented by (1-x-y-z):x:y:z (0≤x≤0.15, 0≤y≤0.15, 0≤z≤0.05, and M is one or more additive elements selected from the group consisting of Al, Fe, Ti, Mg, Ca, Sr, Ba, V, Nb, Cr, Mo, W, Ru, Cu, Zn, B, Ga, Si, Sn, P, Bi, and Zr).

The nickel-containing hydroxide of the present disclosure is preferably a composite hydroxide with a nickel content of 80 mol % or more relative to the total amount of metals in the nickel-containing hydroxide, in which the molar ratio among nickel (Ni): cobalt (Co): manganese (Mn): an additive element M is represented by (1-x-y-z):x:y:z (0≤x≤0.15, 0≤y≤0.15, 0≤z≤0.05, and M is one or more additive elements selected from the group consisting of Al, Fe, Ti, Mg, Ca, Sr, Ba, V, Nb, Cr, Mo, W, Ru, Cu, Zn, B, Ga, Si, Sn, P, Bi, and Zr). For the above, from the viewpoint of obtaining a non-aqueous electrolyte secondary battery having excellent initial charge-discharge efficiency, x is preferably 0.05≤x≤0.14, and particularly preferably 0.07≤x≤0.13, y is preferably 0.01≤y≤0.10, and particularly preferably 0.02≤y≤0.07, and z is preferably 0≤z≤0.03, and particularly preferably 0≤z≤0.02.

Next, the method for producing a nickel-containing hydroxide as a precursor of a cathode active material for a non-aqueous electrolyte secondary battery of the present disclosure, wherein the nickel-containing hydroxide is secondary particles formed by agglomeration of a plurality of primary particles, will be described. The method for producing a nickel-containing hydroxide of the present disclosure comprises a reaction step of obtaining the nickel-containing hydroxide by a crystallization reaction by continuously supplying a metal-containing aqueous solution containing nickel, a complexing agent, and an alkaline aqueous solution to a reaction tank, and a slurry extraction step of continuously extracting a slurry containing the nickel-containing hydroxide from the reaction tank.

### <Reaction Step of Obtaining Nickel-Containing Hydroxide>

The reaction step of obtaining the nickel-containing hydroxide refers to a crystallization step in which a metal-containing aqueous solution containing nickel, an alkaline aqueous solution, and a complexing agent are added and mixed in a reaction tank to perform co-precipitation reaction in the reaction solution, thereby obtaining a nickel-containing hydroxide.

Specifically, according to the co-precipitation method, a metal salt solution containing a nickel salt (e.g., a sulfate) and optional components, i.e., a cobalt salt (e.g., a sulfate), a manganese salt (e.g., a sulfate), and a salt (e.g., a sulfate) of an additive element M (hereinafter sometimes simply referred to as a “metal-containing aqueous solution”), an alkaline aqueous solution, and a complexing agent are added to a reaction tank, and the mixture is neutralized and crystallized in the reaction tank to prepare a nickel-containing hydroxide, thereby obtaining a slurry suspension including the nickel-containing hydroxide. Water, for example, is used as a solvent for the suspension.

The complexing agent is not particularly limited, provided it can form a complex with nickel and optional components of cobalt, manganese, and an additive element M in an aqueous solution. Examples of the complexing agent include an ammonium ion donor (ammonium sulfate, ammonium chloride, ammonium carbonate, ammonium fluoride, or the like), hydrazine, ethylenediaminetetraacetic acid, nitrilotriacetic acid, uracil diacetic acid, and glycine. The alkaline aqueous solution is not particularly limited as long as it is capable of adjusting the pH of the aqueous solution during co-precipitation. Examples of the alkaline aqueous solution include an aqueous solution of alkaline metal hydroxide (such as sodium hydroxide and potassium hydroxide).

When the above metal-containing aqueous solution, alkaline aqueous solution, and complexing agent are continuously supplied to the reaction tank, nickel and optional cobalt, manganese, and additive elements M undergo a crystallization reaction to produce a nickel-containing hydroxide. In the crystallization reaction, the temperature in the reaction tank is controlled, for example, within a range of 10° C. to 80° C., preferably 20 to 70° C., and the material in the reaction tank is appropriately stirred while adjusting the pH in the reaction tank within a range of, for example, pH 9 to pH 13, and preferably pH 10 to 12 based on a liquid temperature of 40° C. Examples of reaction tanks include a continuous reaction tank in which the nickel-containing hydroxide formed is allowed to overflow for separation.

Furthermore, the reaction tank is equipped with a supply pipe for the metal-containing aqueous solution which supplies the metal-containing aqueous solution to the reaction tank, and the metal-containing aqueous solution is supplied to the reaction tank from a storage tank in which the metal-containing aqueous solution is stored through the supply pipe for the metal-containing aqueous solution. In addition to the supply pipe for the metal-containing aqueous solution, the reaction tank is provided with a supply pipe for the alkaline aqueous solution which supplies the alkaline aqueous solution to the reaction tank and a supply pipe for the complexing agent which supplies the complexing agent to the reaction tank.

### <Slurry Extraction Step>

The slurry extraction step refers to a step in which the nickel-containing hydroxide formed in the continuous reaction tank is allowed to overflow through the overflow pipe of the reaction tank and is extracted as a slurry containing the nickel-containing hydroxide.

### <Solid-Liquid Separation Step>

The method may, as necessary, further include a solid-liquid separation step, wherein the slurry containing the nickel-containing hydroxide obtained in the slurry extraction step is filtered, and the nickel-containing hydroxide is washed with an alkaline aqueous solution, and then the resultant is separated into a solid phase and a liquid phase to obtain the solid phase containing the nickel-containing hydroxide. The method may, as necessary, further include a step to obtain a powder of the nickel-containing hydroxide by drying the solid phase containing the nickel-containing hydroxide. Before drying the solid phase, the solid phase may be washed with water or the like as necessary.

In the method for producing a nickel-containing hydroxide of the present disclosure, the flow rate of the metal-containing aqueous solution supplied to the reaction tank in the above reaction step is adjusted to 0.25 m/s or less. Since the flow rate of the metal-containing aqueous solution supplied to the reaction tank is 0.25 m/s or less, the average area of the primary particles of the nickel-containing hydroxide can be adjusted to 0.035 μm² or more, and as a result, a non-aqueous electrolyte secondary battery having excellent initial charge-discharge efficiency can be obtained.

The flow rate (m/s) of the metal-containing aqueous solution supplied to the reaction tank may be calculated from (flow rate (m³/second) of metal-containing aqueous solution flowing through supply pipe for metal-containing aqueous solution)/(cross sectional area (m²) of discharge opening of supply pipe for metal-containing aqueous solution). Thus, the flow rate of the metal-containing aqueous solution supplied to the reaction tank may be adjusted to 0.25 m/s or less by controlling the flow rate of the metal-containing aqueous solution flowing through the supply pipe for the metal-containing aqueous solution based on the cross sectional area of the discharge opening of the supply pipe for the metal-containing aqueous solution.

The flow rate of the metal-containing aqueous solution flowing through the supply pipe for the metal-containing aqueous solution is not particularly limited, and is preferably 1.0×10⁻⁷ m³/second or more and 2.0×10⁻⁴ m³/second or less, more preferably 1.2× 10⁻⁷ m³/second or more and 1.0×10⁻⁴ m³/second or less, and particularly preferably 1.5×10⁻⁷ m³/second or more and 5.0×10⁻⁵ m³/second or less. The cross sectional area of the discharge opening of the supply pipe for the metal-containing aqueous solution is not particularly limited, and is preferably 1.0×10⁻⁶ m² or more and 1.0×10⁻³ m² or less, more preferably 3.0×10⁻⁶ m² or more and 5.0×10⁻⁴ m² or less, and particularly preferably 5.0×10⁻⁶ m² or more and 3.0×10⁻⁴ m² or less.

The flow rate of the metal-containing aqueous solution is not particularly limited as long as it is 0.25 m/second or less, and to further adjust the average area of the primary particles of the nickel-containing hydroxide to 0.035 μm² or more, the flow rate is preferably 0.22 m/second or less, more preferably 0.20 m/second or less, and particularly preferably 0.18 m/second or less.

In the reaction step, the flow rate of the metal-containing aqueous solution supplied to the reaction tank is not particularly limited as long as it is 0.25 m/second or less, and the lower limit value is preferably 0.01 m/second or more, more preferably 0.015 m/second or more, and particularly preferably 0.02 m/second or more because the average area of the primary particles of the nickel-containing hydroxide can be more effectively adjusted to 0.035 μm² or more. The upper limit value and the lower limit value described above may be optionally combined. For example, the flow rate of the metal-containing aqueous solution supplied to the reaction tank is preferably 0.01 m/s or more and 0.25 m/s or less, more preferably 0.01 m/s or more and 0.22 m/s or less, further preferably 0.015 m/s or more and 0.20 m/s or less, and particularly preferably 0.02 m/s or more and 0.18 m/s or less.

Since the flow rate of the metal-containing aqueous solution supplied to the reaction tank is 0.01 m/s or more and 0.25 m/s or less, the average area of the primary particles of the nickel-containing hydroxide can be more effectively adjusted to 0.035 μm² or more, and as a result, a non-aqueous electrolyte secondary battery having excellent initial charge-discharge efficiency can be obtained.

Next, a cathode active material for a non-aqueous electrolyte secondary battery including the nickel-containing hydroxide of the present disclosure as a precursor (hereinafter may be simply referred to as a “cathode active material of the present disclosure”) will be described. The cathode active material of the present disclosure is formed by calcining the nickel-containing hydroxide of the present disclosure, which serves as a precursor, for example, with a lithium compound in one embodiment. Since the nickel-containing hydroxide of the present disclosure is calcined with a lithium compound, a non-aqueous electrolyte secondary battery having excellent initial charge-discharge efficiency can be obtained.

The cathode active material of the present disclosure has a layered crystal structure, and from the viewpoint of obtaining a secondary battery with a high discharge capacity, a trigonal crystal structure, a hexagonal crystal structure, or a monoclinic crystal structure is preferred. The cathode active material of the present disclosure may be used as a cathode active material for a non-aqueous electrolyte secondary battery such as lithium-ion secondary batteries.

When producing the cathode active material of the present disclosure, a step of preparing a nickel-containing oxide from a nickel-containing hydroxide may be performed as a pretreatment if necessary, and the nickel-containing oxide may be used as a precursor. Examples of methods of preparing a nickel-containing oxide from a nickel-containing hydroxide include an oxidation treatment in which calcination is performed under an atmosphere in which oxygen gas is present at a temperature of 300° C. or more and 800° C. or less for 1 hour or more and 10 hours or less.

Next, the method for producing the cathode active material of the present disclosure will be described. For example, in the method for producing the cathode active material of the present disclosure, first a lithium compound is added to the nickel-containing hydroxide (or nickel-containing oxide) to prepare a mixture of the nickel-containing hydroxide (or nickel-containing oxide) and the lithium compound. The lithium compound is not particularly limited, as long as the compound includes lithium, and examples include lithium carbonate and lithium hydroxide.

For the mixing ratio of the lithium compound and the nickel-containing hydroxide (or nickel-containing oxide), for example, the molar ratio of lithium in the lithium compound to the total amount of the metals in the nickel-containing hydroxide (the total amount of nickel and optional components of cobalt, manganese, and additive elements M) is in a range of 1.00 or more and 1.10 or less.

Thereafter, the above mixture can be calcined to produce the cathode active material. The calcination condition includes, for example, a calcination temperature of 600° C. or more and 1,000° C. or less, a temperature-increasing rate of 50° C./hour or more and 300° C./hour or less, and a calcination time of 5 hours or more and 20 or less. The calcination atmosphere is not particularly limited, and examples include air, oxygen, and the like. The calcination furnace used for calcination is not particularly limited, and the examples include a stationary box furnace, a roller hearth continuous furnace, and the like.

Next, a cathode using the cathode active material of the present disclosure will be described. A cathode has a cathode current collector and a cathode active material layer using the cathode active material of the present disclosure formed on the surface of the cathode current collector. The cathode active material layer includes the cathode active material of the present disclosure, a binder, and, as necessary, a conductive auxiliary. The conductive auxiliary is not particularly limited as long as the conductive auxiliary can be used for non-aqueous electrolyte secondary batteries, and for example, a carbon material may be used. Examples of carbon materials include graphite powder, carbon black (e.g., acetylene black) and a fibrous carbon material. The binder is not particularly limited, and for example, a thermoplastic resin may be used. Examples of the thermoplastic resins include polyvinylidene fluoride (PVdF), butadiene rubber (BR), polyvinyl alcohol (PVA), carboxymethylcellulose (CMC) and polytetrafluoroethylene (PTFE), and a combination thereof. The cathode current collector is not particularly limited, and the examples include a conductive metal material such as aluminum foil, nickel foil and stainless steel.

The method for producing a cathode includes, for example, preparing a cathode active material slurry by mixing a cathode active material, a conductive auxiliary and a binder. The above cathode active material slurry is filled into the cathode current collector by a known filling method, dried, and rolled to adhere to the cathode current collector by a press or the like.

A cathode using the cathode active material obtained as described above, an anode, an electrolyte solution containing predetermined electrolytes, and a separator are prepared by a known method, and a non-aqueous electrolyte secondary battery can be assembled.

Examples of anodes include an electrode formed from an anode active material layer using an anode active material supported by an anode current collector, and an electrode composed only of an anode active material. The anode active material is not particularly limited as long as it is commonly used, and the examples include graphite such as natural graphite and artificial graphite, coke, carbon black, pyrolytic carbon, carbon fiber, and calcined organic polymer compound may be used. The anode current collector is not particularly limited, and the examples include a metal material such as copper foil, nickel foil, and stainless steel.

Furthermore, a conductive auxiliary, a binder, or the like may be added to the anode active material layer, as necessary. Examples of conductive auxiliaries and binders are the similar as those used for the above cathode active material layer.

The method for producing an anode includes, for example, preparing an anode active material slurry by mixing an anode active material, optionally a conductive auxiliary, and a binder, with water. Then, the above anode active material slurry is filled into the anode current collector by a known filling method, dried, and rolled to adhere to the anode current collector by a press or the like.

Examples of electrolytes in non-aqueous electrolytes include a lithium salt such as LiClO₄, LiPF₆, LiASF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (in which BOB refers to bis(oxalato)borate), LiFSI (in which FSI refers to bis(fluorosulfonyl)imide), lower aliphatic lithium carboxylate and LiAlCl₄. These may be used singly or two or more of them may be used in combination.

As a dispersion medium of electrolyte, for example, a carbonate such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy) ethane; an ether such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; an ester such as methyl formate, methyl acetate and γ-butyrolactone; a nitrile such as acetonitrile and butyronitrile; an amide such as N,N-dimethylformamide and N,N-dimethylacetamide; a carbamate such as 3-methyl-2-oxazolidone; a sulfur-containing compound such as sulfolane, dimethyl sulfoxide and 1,3-propanesultone, or an organic solvent into which fluoro groups are introduced (an organic solvent in which one or more hydrogen atoms are substituted with a fluorine atom) may be used. These may be used singly or two or more of them may be used in combination.

A solid electrolyte may also be used instead of the electrolyte solution containing electrolyte. Examples of solid electrolytes include an organic polyelectrolyte such as a polyethylene oxide polymer compound and a polymer compound including at least one polyorganosiloxane chain or polyoxyalkylene chain. What is called a gel-type polymer electrolyte, comprising a polymer compound retaining a non-aqueous electrolyte, may also be used. Examples also include an inorganic solid electrolyte containing a sulfide, such as Li₂S—SiS₂, Li₂S—GeS₂, Li₂S—P₂S₅, Li₂S—B₂S₃, Li₂S—SiS₂—Li₃PO₄, Li₂S—SiS₂—Li₂SO₄ and Li₂S—GeS₂—P₂S₅. These may be used singly or two or more of them may be used in combination.

The separator is not particularly limited, and a material in the form of a porous film, a nonwoven fabric, or a woven fabric may be used, which is formed from a material such as a polyolefin resin including polyethylene and polypropylene, a fluororesin or a nitrogen-containing aromatic polymer. These may be used singly or two or more of them may be used in combination.

### EXAMPLES

Next, Examples of the nickel-containing hydroxide of the present disclosure will be described, but the present disclosure is not limited to these Examples, provided it does not depart from the subject matter of the disclosure.

### Production of Nickel-Containing Hydroxide of Examples and Comparative Examples

### Production of Nickel-Containing Hydroxide of Example 1

A metal-containing aqueous solution prepared by dissolving nickel sulfate, cobalt sulfate, and manganese sulfate at a predetermined molar ratio of nickel:cobalt:manganese, an aqueous ammonium sulfate solution (a complexing agent) and an aqueous sodium hydroxide solution were added dropwise to a reaction tank having a predetermined capacity. The mixture was continuously stirred by a stirrer while maintaining the temperature in the reaction tank at 70° C. and the pH in the reaction tank at 10.5 based on a liquid temperature of 40° C. The flow rate of the metal-containing aqueous solution added dropwise to the reaction tank was adjusted to 0.06 m/s. The hydroxide generated was caused to overflow through the overflow pipe of the reaction tank and recovered. The hydroxide recovered was subjected to water-washing, dehydration, and drying treatments to obtain the nickel-containing hydroxide.

### Production of Nickel-Containing Hydroxide of Example 2

A metal-containing aqueous solution prepared by dissolving nickel sulfate, cobalt sulfate, and manganese sulfate at a predetermined molar ratio of nickel:cobalt:manganese, an aqueous ammonium sulfate solution (a complexing agent) and an aqueous sodium hydroxide solution were added dropwise to a reaction tank having a predetermined capacity. The mixture was continuously stirred by a stirrer while maintaining the temperature in the reaction tank at 70° C. and the pH in the reaction tank at 11.2 based on a liquid temperature of 40° C. The flow rate of the metal-containing aqueous solution added dropwise to the reaction tank was adjusted to 0.16 m/s. The nickel-containing hydroxide of Example 2 was prepared by performing the subsequent steps in the same manner as in Example 1.

### Production of Nickel-Containing Hydroxide of Example 3

A metal-containing aqueous solution prepared by dissolving nickel sulfate, cobalt sulfate, and manganese sulfate at a predetermined molar ratio of nickel:cobalt:manganese, an aqueous ammonium sulfate solution (a complexing agent) and an aqueous sodium hydroxide solution were added dropwise to a reaction tank having a predetermined capacity. The mixture was continuously stirred by a stirrer while maintaining the temperature in the reaction tank at 70° C. and the pH in the reaction tank at 11.4 based on a liquid temperature of 40° C. The flow rate of the metal-containing aqueous solution added dropwise to the reaction tank was adjusted to 0.02 m/s. The nickel-containing hydroxide of Example 3 was prepared by performing the subsequent steps in the same manner as in Example 1.

### Production of Nickel-Containing Hydroxide of Example 4

A metal-containing aqueous solution prepared by dissolving nickel sulfate, cobalt sulfate, and manganese sulfate at a predetermined molar ratio of nickel:cobalt:manganese, an aqueous ammonium sulfate solution (a complexing agent) and an aqueous sodium hydroxide solution were added dropwise to a reaction tank having a predetermined capacity. The mixture was continuously stirred by a stirrer while maintaining the temperature in the reaction tank at 70° C. and the pH in the reaction tank at 11.3 based on a liquid temperature of 40° C. The flow rate of the metal-containing aqueous solution added dropwise to the reaction tank was adjusted to 0.07 m/s. The nickel-containing hydroxide of Example 4 was prepared by performing the subsequent steps in the same manner as in Example 1.

### Production of Nickel-Containing Hydroxide of Example 5

A metal-containing aqueous solution prepared by dissolving nickel sulfate, cobalt sulfate, and manganese sulfate at a predetermined molar ratio of nickel:cobalt:manganese, an aqueous ammonium sulfate solution (a complexing agent) and an aqueous sodium hydroxide solution were added dropwise to a reaction tank having a predetermined capacity. The mixture was continuously stirred by a stirrer while maintaining the temperature in the reaction tank at 70° C. and the pH in the reaction tank at 11.3 based on a liquid temperature of 40° C. The flow rate of the metal-containing aqueous solution added dropwise to the reaction tank was adjusted to 0.16 m/s. The nickel-containing hydroxide of Example 5 was prepared by performing the subsequent steps in the same manner as in Example 1.

### Production of Nickel-Containing Hydroxide of Comparative Example 1

A metal-containing aqueous solution prepared by dissolving nickel sulfate, cobalt sulfate, and manganese sulfate at a predetermined molar ratio of nickel:cobalt:manganese, an aqueous ammonium sulfate solution (a complexing agent) and an aqueous sodium hydroxide solution were added dropwise to a reaction tank having a predetermined capacity. The mixture was continuously stirred by a stirrer while maintaining the temperature in the reaction tank at 75° C. and the pH in the reaction tank at 11.4 based on a liquid temperature of 40° C. The flow rate of the metal-containing aqueous solution added dropwise to the reaction tank was adjusted to 0.31 m/s. The nickel-containing hydroxide of Comparative Example 1 was prepared by performing the subsequent steps in the same manner as in Example 1.

The evaluation parameters for physical properties of the nickel-containing hydroxides of Examples and Comparative Examples are as follows.

### (1) Composition Analysis of Nickel-Containing Hydroxide

The composition analysis was performed by using an inductively coupled plasma optical emission spectrometer (Optima 8300DV made by PerkinElmer Japan) after dissolving the obtained nickel-containing hydroxide in hydrochloric acid.

### (2) Average Area of Primary Particles of Nickel-Containing Hydroxide

For each of the nickel-containing hydroxide particles of Examples and Comparative Examples, an image of secondary particles was obtained by scanning electron microscope (SEM) observation at a magnification of 5,000 times. From the obtained image, secondary particles having a particle size at a cumulative volume percentage of 50% (D50) (±10%) as measured by a particle size distribution measurement device using the laser diffraction-scattering method were selected. Subsequently, for the selected secondary particles, 40 primary particles on the surface were randomly selected from the scanning electron microscope (SEM) image at a magnification of 20,000 times, and the area of the respective 40 primary particles selected was measured using an image processing software “ImageJ.” Thereafter the average area of the primary particles was calculated from the measured areas of the 40 primary particles.

The evaluation results of physical properties of the nickel-containing hydroxides of Examples and Comparative Examples are shown in the following Table 1.

### Production of Cathode Active Material Using Nickel-Containing Hydroxide of Examples and Comparative Examples as Precursor

A lithium hydroxide powder was added to and mixed with each of the nickel-containing hydroxides of Examples and Comparative Examples at a molar ratio of Li/(Ni+Co+Mn) of 1.05, to prepare a mixture of the nickel-containing hydroxide and lithium hydroxide. The mixture prepared was subjected to calcination to obtain a lithium metal composite oxide for use as a cathode active material. The calcination conditions were an oxygen atmosphere, a temperature-increasing rate of 160° C./hour, a calcination temperature of 750° C. and a calcination time of 5 hours.

### Production of Cathode Using Cathode Active Material

A cathode was prepared using the cathode active material obtained as described above, and a battery for evaluation was assembled by using the cathode prepared. Specifically, the obtained cathode active material, a conductive auxiliary (acetylene black), and a binder (PVdF) were mixed at a weight ratio of 92:5:3, and the resulting mixture was applied to a cathode current collector (aluminum foil), dried and pressed to adhere to the cathode current collector, thereby forming a cathode.

A lithium secondary battery was prepared by using the cathode obtained as described above, an anode (metal lithium), an electrolyte solution containing electrolyte (LiPF₆) (a mixed solution of ethylene carbonate:dimethyl carbonate:ethyl methyl carbonate mixed at a volume ratio of 30:35:35), and a separator (made of polypropylene).

### Evaluation Parameters for Lithium Secondary Battery

### Initial Charge-Discharge Efficiency

An initial charge/discharge test was performed using the lithium secondary battery prepared under the following conditions. The ratio of the initial discharge capacity to the initial charge capacity, expressed as a percentage, was determined as the initial charge-discharge efficiency.

### <Charge/Discharge Test Conditions>

Test temperature: 25° C.
Maximum charge voltage 4.3 V, Charge current 0.2 CA, Constant current constant voltage charging
Minimum discharge voltage 2.5 V, Discharge current 0.2 CA, Constant current discharging

When the initial charge-discharge efficiency was 83.0% or more, the initial charge-discharge efficiency was rated as high.

The evaluation results of the lithium secondary batteries of Examples and Comparative Examples are shown in the following Table 1.

TABLE 1

| | Nickel-containing hydroxide | | | |
|---|---|---|---|---|
| | | | Flow rate | |
| | | Average | of metal- | Initial |
| | | area | containing | charge- |
| | | of primary | aqueous | discharge |
| | Composition | particles | solution | efficiency |
| | [Ni/Co/Mn] | [μm²] | [m/s] | [%] |
| Example 1 | 83/12/5 | 0.071 | 0.06 | 91.2 |
| Example 2 | 83/12/5 | 0.057 | 0.16 | 85.1 |
| Example 3 | 88/9/3 | 0.050 | 0.02 | 86.3 |
| Example 4 | 88/9/3 | 0.042 | 0.07 | 83.9 |
| Example 5 | 88/9/3 | 0.039 | 0.16 | 83.3 |
| Comparative | 83/12/5 | 0.030 | 0.31 | 81.8 |
| Example 1 | | | | |

Table 1 shows that in Examples 1 to 5 in which the primary particles of the nickel-containing hydroxide had an average area of 0.035 μm² or more, excellent initial charge-discharge efficiency of 83.0% or more was achieved. In Examples 1 to 5, the flow rate of the metal-containing aqueous solution added dropwise to the reaction tank was adjusted to 0.25 m/s or less. Furthermore, Examples 1 to 3 show that when the primary particles of the nickel-containing hydroxide had an average area of 0.050 μm² or more, higher initial charge-discharge efficiency of 85.0% or more was achieved.

On the other hand, Table 1 shows that in Comparative Example 1 in which the primary particles of the nickel-containing hydroxide had an average area of 0.030 μm², the initial charge-discharge efficiency was 81.8%, and excellent initial charge-discharge efficiency was not achieved. Furthermore, in Comparative Example 1, the flow rate of the metal-containing aqueous solution added dropwise to the reaction tank was 0.31 m/s, which was not adjusted to 0.25 m/s or less.

When a cathode active material prepared from the nickel-containing hydroxide of the present disclosure as a precursor is used in a secondary battery, excellent initial charge-discharge efficiency is exhibited, and thus the nickel-containing hydroxide can be used in a wide range of secondary battery applications, such as portable devices and vehicles.

1. A nickel-containing hydroxide as a precursor of a cathode active material for a non-aqueous electrolyte secondary battery, wherein the nickel-containing hydroxide is secondary particles formed by agglomeration of a plurality of primary particles, and the primary particles have an average area of 0.035 μm² or more.

2. The nickel-containing hydroxide according to claim 1, wherein the primary particles have an average area of 0.100 μm² or less.

3. The nickel-containing hydroxide according to claim 1, wherein the primary particles have an average area of 0.039 μm² or more and 0.080 μm² or less.

4. The nickel-containing hydroxide according to claim 1, wherein the nickel-containing hydroxide comprises 80 mol % or more of nickel (Ni) relative to a total amount of metals in the nickel-containing hydroxide.

5. The nickel-containing hydroxide according to claim 4, wherein the nickel-containing hydroxide is a composite hydroxide comprising nickel (Ni) and at least one metal selected from the group consisting of cobalt (Co) and manganese (Mn).

6. The nickel-containing hydroxide according to claim 4, wherein the nickel-containing hydroxide is a composite hydroxide in which a molar ratio among nickel (Ni): cobalt (Co): manganese (Mn): an additive element M is represented by (1-x-y-z):x:y:z (0≤x≤0.15, 0≤y≤0.15, 0≤z≤0.05, and M is one or more additive elements selected from the group consisting of Al, Fe, Ti, Mg, Ca, Sr, Ba, V, Nb, Cr, Mo, W, Ru, Cu, Zn, B, Ga, Si, Sn, P, Bi, and Zr).

7. A cathode active material for a non-aqueous electrolyte secondary battery, wherein the cathode active material is formed by calcining the nickel-containing hydroxide according to claim 1 with a lithium compound.

8. A method for producing a nickel-containing hydroxide as a precursor of a cathode active material for a non-aqueous electrolyte secondary battery, wherein the nickel-containing hydroxide is secondary particles formed by agglomeration of a plurality of primary particles, the method comprising:
obtaining the nickel-containing hydroxide by a crystallization reaction by continuously supplying a metal-containing aqueous solution containing nickel, a complexing agent, and an alkaline aqueous solution to a reaction tank, and
continuously extracting a slurry containing the nickel-containing hydroxide from the reaction tank,
wherein a flow rate of the metal-containing aqueous solution containing nickel supplied to the reaction tank is 0.25 m/s or less.

9. The method for producing a nickel-containing hydroxide according to claim 8, wherein the flow rate of the metal-containing aqueous solution containing nickel supplied to the reaction tank is 0.01 m/s or more.

10. The method for producing a nickel-containing hydroxide according to claim 8, wherein the nickel-containing hydroxide extracted from the reaction tank is washed with an alkaline aqueous solution and is then subjected to solid-liquid separation.
